(19) United States
(12) Patent Application Publication
(10) Pub. No.: US 2025/0376376 A1
(43) Pub. Date: Dec. 11, 2025

(54) PROCESS FOR PREPARING HYDRAZINE HYDRATE USING AN ABSORPTION COLUMN

(71) Applicant: ARKEMA FRANCE, Colombes (FR)

(72) Inventors: Jean-Marc SAGE, Colombes (FR); Valérie HENRARD, Colombes (FR)

(21) Appl. No.: 18/875,687

(22) PCT Filed: Jun. 23, 2023
(86) PCT No.: PCT/FR2023/050949

§ 371 Date: Dec. 16, 2024

(30) Foreign Application Priority Data
Jun. 24, 2022 (FR) FR2206298

(51) Int. Cl. C01B 21/16

(52) U.S. Cl. CPC C01B 21/16

(57) ABSTRACT

The invention relates to a process for preparing hydrazine hydrate, comprising the following successive steps:
a) preparation by means of an absorption column of an aqueous solution comprising dissolved ammonia and comprising at least one activator, by introduction into the absorption column of an aqueous solution comprising at least one activator and of fresh ammonia, then
b) reaction within at least one reactor of the aqueous ammonia solution comprising at least one activator obtained in the preceding step with hydrogen peroxide and a ketone, then
c) separation of the organic phase containing the azine from the aqueous phase from the stream formed on conclusion of the preceding step, then
d) hydrolysis of the organic phase obtained in the preceding step to obtain hydrazine hydrate.

The present invention relates to a process for preparing hydrazine hydrate from an alkyl ketone azine obtained in the presence of a ketone by oxidation of ammonia with hydrogen peroxide, in the presence of an activator.

Hydrazine is employed in a variety of different applications, primarily in the deoxygenation of boiler waters (of nuclear power stations, for example), and is used for preparing pharmaceutical and agrochemical derivatives.

There is therefore an industrial need for the preparation of hydrazine hydrate.

Hydrazine hydrate is produced industrially by the Raschig or Bayer processes or from hydrogen peroxide.

In the Raschig process, ammonia is oxidized with a hypochlorite to give a dilute solution of hydrazine hydrate, which must then be concentrated by distillation. This process, being relatively unselective, relatively unproductive and highly polluting, is virtually no longer used.

The Bayer process is an improvement on the Raschig process, which involves shifting a chemical equilibrium by using acetone to trap the hydrazine formed in the form of azine of the following formula:

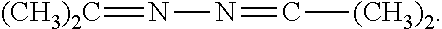

The azine is subsequently isolated and then hydrolysed to hydrazine hydrate. Yields are improved, but there is no improvement in environmental emissions.

The hydrogen peroxide process involves oxidizing a mixture of ammonia and a ketone with hydrogen peroxide in the presence of a means for activating the hydrogen peroxide to synthesize the azine directly, which then only needs to be hydrolysed to hydrazine hydrate. The yields are high and the process is less polluting. This hydrogen peroxide process is described in numerous patents, for example U.S. Pat. Nos. 3,972,878, 3,972,876 and 4,093,656.

These processes are also described in Ullmann's Encyclopedia of Industrial Chemistry (1989), vol. A 13, pages 180-183 and the references included.

In the hydrogen peroxide processes, the ammonia is oxidized with the hydrogen peroxide in the presence of a ketone and a means for activating the hydrogen peroxide according to the following overall reaction, forming an azine:

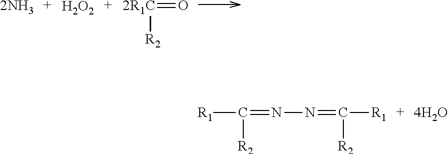

The activation means, or activator, may be a nitrile, an amide, a carboxylic acid or else a selenium, antimony or arsenic derivative. The azine is then hydrolysed to hydrazine and the ketone is regenerated according to the following reaction:

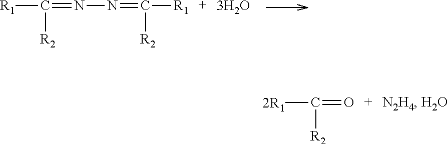

This hydrolysis is actually performed in two stages, with formation of an intermediate hydrazone:

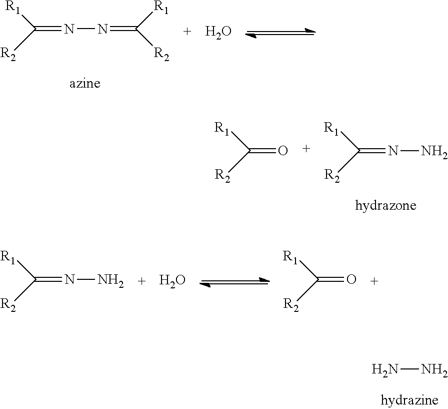

The reaction for forming azine is relatively complex, since it involves three phases: a gaseous phase with the ammonia, an organic phase with the ketone, and an aqueous phase with the activator and the hydrogen peroxide. Methyl ethyl ketone is advantageously used, since the azine of methyl ethyl ketone is soluble in the organic phase and poorly soluble in the aqueous medium. It can therefore be easily recovered at the end of the reaction and separated by simple decanting. This azine also has the advantage of being very stable, particularly in an alkaline medium, i.e. in the ammoniacal reaction medium.

In the current processes, this azine is subsequently purified, and then hydrolysed in a reactive distillation column to finally release methyl ethyl ketone at the top, which may be recycled, and above all an aqueous solution of hydrazine hydrate at the bottom. This must contain as few carbon products as possible as impurities and must be colourless.

A process for efficiently preparing hydrazine hydrate is known from document WO 2020/229773.

It is known from the scientific article ‘Agitation Effects in a Gas-Liquid-Liquid Reactor System: Methyl Ethyl Ketazine Production’ by R. Kaur and K. D. P. Nigam in the journal International Journal of Chemical Reactor Engineering, from January 2007, that the agitation is a decisive improvement factor. Specifically, for the reaction to be efficient, it is necessary for the reactants to come into contact with one another, i.e. the ammonia in the gas phase, the hydrogen peroxide and the activator in the aqueous phase and the ketone in the organic phase. The yield of this reaction is directly linked to the exchanges and contacts between the various phases. The aforementioned publication studies the yield of the reaction as a function of the agitation speed of the reaction medium and as a function of the number of phases present in the reactor.

It is observed that the higher the agitation speed, the more the yield increases, up to a threshold value of 600 rpm. However, these experiments were carried out in a semi-batch reactor. Now, this process is difficult to transfer to industrial units, i.e. to much greater volumes. Agitation of 600 rpm applied to industrial-volume reactors represents a significant consumption of energy. This level of agitation is difficult to realize when the process is applied to industrial amounts.

Consequently, solutions are still sought in order to make these gas-liquid-liquid contacts efficient, with a satisfactory yield, a reasonable energy consumption and a simple installation, within an industrial process.

This technical problem has been solved by a process for mixing various phases in two steps. Firstly, gaseous ammonia is dissolved in the aqueous phase using an absorption column, then this ammoniacal aqueous phase is mixed with the organic phase in a conventional agitated reactor.

This solution makes it possible to use a standard liquid-liquid two-phase reactor, with a level of agitation which is itself also standard. It has been observed that very good yields were obtained even at a very low level of agitation.

### BRIEF DESCRIPTION OF THE FIGURE

FIG. 1 is a diagram of the device implementing the claimed process.

### BRIEF DESCRIPTION OF THE INVENTION

Thus, a subject of the present invention is a process for preparing hydrazine hydrate, comprising the following successive steps:
a) preparation by means of an absorption column of an aqueous solution comprising dissolved ammonia in a proportion of between 50% and 100% relative to the saturation of ammonia in pure water at the temperature of the column and comprising at least one activator, by introduction into the absorption column of an aqueous solution comprising at least one activator and of fresh ammonia, then
b) reaction within at least one reactor of the aqueous ammonia solution comprising at least one activator obtained in the preceding step with hydrogen peroxide and a ketone of formula R₁R₂CO, the groups R₁ and R₂ denoting, independently of one another, a methyl, ethyl, propyl, butyl, pentyl, hexyl, heptyl and octyl group, then
c) separation of the organic phase containing the azine from the aqueous phase from the stream formed on conclusion of the preceding step, then
d) hydrolysis of the organic phase obtained in the preceding step to obtain hydrazine hydrate.

### DETAILED DESCRIPTION OF THE INVENTION

Other features, aspects, subjects and advantages of the present invention will become even more clearly apparent from reading the description that follows.

It is specified that the expressions “from . . . to . . . ” and “between . . . and . . . ” used in the present description should be understood as including each of the limits mentioned.

### Preparation of the Aqueous Solution

An ammoniacal aqueous solution is prepared using an absorption column.

The absorption column is fed with fresh ammonia and with an aqueous solution containing at least one activator.

The absorption column aims to dissolve the gaseous ammonia in the aqueous solution containing at least one activator. The function of the absorption column is to make this mixture of gaseous ammonia and of aqueous solution comprising an activator into a single phase.

At the outlet of the absorption column, an aqueous solution comprising dissolved ammonia in a proportion of between 50% and 100% relative to the saturation of ammonia in pure water at the temperature of the column and comprising at least one activator is obtained.

### Dissolved Ammonia

The solubility of gaseous ammonia in pure water as a function of the temperature is known from the book Lange's Handbook of Chemistry, Editor John A. Dean, 12^{th} edition, 1979, on page 10.3. This solubility is expressed as weight of gas dissolved in 100 grams of water at a pressure of 760 mm of mercury. The table disclosed on page 10.3 is reproduced below:

TABLE 1

| Temperature (° C.) | Amount in grams |
|---|---|
| 20 | 52.9 |
| 24 | 48.2 |
| 28 | 44.0 |
| 30 | 41.0 |
| 40 | 31.6 |
| 50 | 23.5 |
| 60 | 16.8 |
| 70 | 11.1 |

These values express the maximum solubility of ammonia in pure water, i.e. the saturation of pure water by ammonia. In the context of the invention, the absorption column aims to dissolve ammonia in the aqueous solution containing activator at a percentage of between 50% and 100% relative to a saturated pure water at the temperature of the column. This solubility of ammonia in the aqueous phase is expressed relative to the amount of water contained in the aqueous phase comprising at least one activator.

In other words, starting from the values that are disclosed in the aforementioned Lange's Handbook of Chemistry and reproduced in Table 1 above, at 20° C., a dissolution of ammonia of 26.45 g to 52.9 g of ammonia is targeted. At 70° C., a dissolution of 5.55 g to 11.1 g of ammonia is targeted.

Preferably, ammonia is dissolved in the aqueous solution containing activator in a proportion of between 50% and 85% relative to the saturation of ammonia in pure water at the temperature of the column.

The flow rate of fresh ammonia may vary during the process in order to keep constant the solubility of the ammonia in the aqueous solution. At the start of the process, the flow rate of ammonia will have to be sufficient to achieve the desired ammonia solubility. Subsequently, the flow rate will be able to be reduced so as to maintain the desired solubility.

### The Activator

“Activator” is understood to mean a compound enabling the activation of the hydrogen peroxide, i.e. a compound that enables the azine to be produced from ammonia, hydrogen peroxide and a ketone.

This activator may be selected from organic or inorganic oxyacids, ammonium salts thereof and derivatives thereof: anhydrides, esters, amides, nitriles, acyl peroxides, or mixtures thereof. Advantageously, use is made of amides, ammonium salts and nitriles. By way of example, mention may be made of:
(i) amides of carboxylic acids of formula R₅COOH in which R₅ is hydrogen, a linear alkyl radical having from 1 to 20 carbon atoms, or a branched or cyclic alkyl radical having from 3 to 12 carbon atoms, or an unsubstituted or substituted phenyl radical,
(ii) amides of polycarboxylic acids of formula R₆(COOH) n in which R₆ represents an alkylene radical having from 1 to 10 carbon atoms and n is an integer greater than or equal to 2; R₆ may be a single bond, in which case n is 2.

The radicals R₅ and R₆ may be substituted by halogens or by OH, NO₂ or methoxy groups. Mention may also be made of the amides of organic acids of arsenic. Organic acids of arsenic are, for example, methylarsonic acid, phenylarsonic acid and cacodylic acid.

The preferred amides are formamide, acetamide, monochloroacetamide and propionamide, and more preferentially acetamide.

Among the ammonium salts, use is advantageously made of the salts of hydracids, of inorganic oxyacids, of arylsulfonic acids, of acids of formula R₅COOH or R₆(COOH)ₙ, where R₅, R₆ and n are as defined above, and of organic acids of arsenic.

The preferred ammonium salts are formate, acetate, monochloroacetate, propionate, phenylarsonate and cacodylate.

Among the nitriles, mention may advantageously be made of the products of formula R₇(CN)ₙ, where n may range from 1 to 5 depending on the valence of R₇, R₇ is a cyclic or noncyclic alkyl having from 1 to 12 carbon atoms or a benzyl or a pyridinyl group. R₇ may be substituted by groups which are not oxidized in the reactor of step (b), for example halogens or carboxyl, carboxylic ester, nitro, amine, hydroxyl or sulfonic acid groups.

The preferred nitriles are acetonitrile and propionitrile.

The solution comprising at least one activator is formed by dissolving one or more products selected from organic or inorganic oxyacids, ammonium salts thereof and derivatives thereof: anhydrides, esters, amides, nitriles, acyl peroxides, or mixtures thereof as defined above. Advantageously, use is made of the above nitriles, ammonium salts or amides. Particularly preferably, use is made of a single activator, which is acetamide.

This solution is aqueous. According to another embodiment, said solution is an aqueous solution of an amide of a weak acid and the ammonium salt corresponding to this acid, as described in patent EP 0 487 160.

These weak-acid amides are derivatives of the corresponding carboxylic acids that have a dissociation constant of less than 3×10⁻³, in other words acids that have a pKa of greater than 3 in aqueous solution at 25° C.

For polycarboxylic acids, the acids in question are those for which the first ionization constant is less than 3×10⁻³.

By way of example, mention may be made of carboxylic acids of formula R₈COOH in which R₈ is a linear alkyl radical having from 1 to 20 carbon atoms, or a branched or cyclic alkyl radical having from 3 to 12 carbon atoms, or an unsubstituted or substituted phenyl radical, and polycarboxylic acids of formula R₉(COOH)ₙ in which R₉ represents an alkylene radical having from 1 to 10 carbon atoms and n is a number greater than or equal to 2; R₉ may be a single bond, in which case n is 2. The radicals R₈ and R₉ may be substituted by halogens or by OH, NO₂ or methoxy groups. Preference is given to using acetamide, propionamide, n-butyramide or isobutyramide.

The corresponding ammonium salt of acetamide is ammonium acetate.

It would not be outside the scope of the invention to form the ammonium salt in situ, i.e. to use the corresponding carboxylic acid which, by reaction with ammonia, gives the ammonium salt.

The proportions of the amide and of the corresponding ammonium salt may vary within wide limits. Use is commonly made of 1 to 25 parts of the ammonium salt per 5 parts of amide, and preferably 2 to 10.

### The Apparatus

The temperature of the absorption column may be between ambient temperature and 70° C., preferably between 20° C. and 50° C., and preferably between 25° C. and 45° C. The pressure of the absorption column may be between atmospheric pressure and up to about 10 bar absolute. Preferably, the reaction is carried out at between 1 and 5 bar absolute.

The column may be a packed or plate distillation column.

It is also possible to completely or partially recover the stream(s) of ammonia generated by the process for preparing the azine.

The aqueous solution containing at least one activator may be a recycled aqueous solution, which originates from the separation step c), which may have completely or partially undergone a regeneration and concentration step.

Preferably, the aqueous solution comprising at least one activator is introduced at the top of the column and the fresh ammonia and/or any recycled ammonia is introduced in countercurrent, preferably at the bottom of the column. The meeting of these streams in countercurrent enables better mixing of the reactants and better absorption of the gaseous ammonia into the aqueous solution.

The ammoniacal aqueous solution comprising at least one activator is then introduced into the reactor, in which the reaction to form the azine is performed.

### b) Mixing Reaction

The mixing reaction is carried out within at least one reactor. The aqueous solution comprising dissolved ammonia in a proportion of between 50% and 100% relative to the saturation of ammonia in pure water at the temperature of the column and comprising at least one activator, obtained in the preceding step, hydrogen peroxide and the ketone of formula R₁R₂CO, the groups R₁ and R₂ denoting, independently of one another, a methyl, ethyl, propyl, butyl, pentyl, hexyl, heptyl and octyl group, are introduced into the reactor.

### Hydrogen Peroxide

Hydrogen peroxide may be used in its common commercial form, for example in aqueous solution comprising between 30% and 90% by weight of oxygen peroxide. Advantageously, it is possible to add one or more customary stabilizers for peroxide solutions, for example phosphoric, pyrophosphoric, citric, nitrilotriacetic or ethylenediaminetetraacetic acid or the ammonium or alkali metal salts of these acids.

It is also known practice to stabilize the hydrogen peroxide solutions by adding sequestering agents thereto, which will complex the metal ions. This inhibits the redox reaction of the hydrogen peroxide.

Sequestering agents particularly used to stabilize the hydrogen peroxide solutions are compounds of the type comprising phosphonic functions, in their acid form or in their salt form.

The following commercial products may be used:
the product sold under the name DEQUEST® 2060 by the company Monsanto, which is an aqueous solution of 50% diethylenetriamine penta (methylene phosphonic acid),
the product sold under the name DEQUEST® 2041, which is an aqueous solution of ethylenediamine tetra (methylene phosphonic acid),
the products sold under the names DEQUEST® 2010 and 2006, respectively an aqueous solution of 60% 1-hydroxyethylidene-1,1-diphosphonic acid and an aqueous solution of 29% aminotris (methylenephosphonic acid) and 40% pentasodium salt of this acid.

These acids may also be used in their acid form or else completely or partially neutralized form, for example in the form of the sodium salt or the ammonium salt.

The amount to be used is advantageously between 10 and 1000 ppm and preferably between 50 and 250 ppm of all of the reactants and the solution comprising at least one activator at the inlet of the reactor.

### The Alkyl Ketone

The alkyl ketone of formula R₁R₂CO comprises groups R₁ and R₂ denoting, independently of one another, a methyl, ethyl, propyl, butyl, pentyl, hexyl, heptyl and octyl group. Preferably, dimethyl ketone and methyl ethyl ketone are used. Particularly preferably, methyl ethyl ketone is used. Hence, the preferred azine is the azine of methyl ethyl ketone, called MEKazine.

The reactants may be used in stoichiometric amounts. However, it is possible to use from 0.2 to 5 mol and preferably from 1.5 to 4 mol of ketone, and from 0.1 to 10 mol and preferably from 1.5 to 4 mol of ammonia, per mole of hydrogen peroxide. The amount of solution comprising at least one activator may be between 0.1 and 2 kg per mole of hydrogen peroxide. This amount depends on its quality, i.e. on its catalytic strength or its activity which enables conversion of the reactants to azine. The above-stipulated proportions of the reactants make it possible to obtain a maximum conversion, typically greater than 90%, preferably greater than 95%, of hydrogen peroxide and a production of azine corresponding to more than 75% of the hydrogen peroxide employed, and possibly reaching 90%.

### The Conditions of the Mixing

The reaction may be performed within a very wide temperature range, for example between 0° C. and 100° C., and operation is advantageously between 30° C. and 70° C. While operation is possible at any pressure, it is simpler to be at atmospheric pressure, although an increase up to approximately 10 bar absolute is possible. Preferably, the reaction is carried out at between 1 and 5 bar absolute.

### The Reactor

The reactor may have an internal diameter of between 1 and 6 m, preferably between 2 and 5 m. The working height of the reactor may be between 1 and 10 m, preferably between 3 and 7 m. Thus, the reaction volume may be between 25 and 100 m³, preferably between 40 and 70 m³.

The reactor may be equipped with means enabling agitation, for example blades.

Thus, the reactor may comprise several agitation stages, preferably two agitation stages. Each agitation stage may comprise several inclined blades. Preferably, the blades are positioned in the lower third of the reactor and in the upper third of the reactor. The diameter of the agitation rotating elements depends on the diameter of the reactor. Generally, the diameter of the rotating element is between 30% and 70% of the diameter of the reactor.

The reactor according to the invention is not a microreactor.

It is also possible to use several reactors arranged in cascade. According to this embodiment, the reaction may take place in at least two reactors arranged in cascade. Preferably, 3, 4 or 5 reactors in cascade are used. The reactors may have the same volume or else a different volume.

Preferably, the agitation in the first reactor is less than the agitation of the second reactor, and of any following reactor(s).

For the purposes of the present invention, agitation is understood to mean the speed of the stream of the reaction medium within the reactor that is generated by the movement of a rotating element, such as a blade, an anchor or any other rotating element, optionally in the presence of a baffle, or else by a Venturi effect. For a medium agitated by a rotating element, the agitation of the reaction medium can be expressed by the agitation speed of the rotating element itself.

According to a particular embodiment of the invention, when the process uses 2, 3 reactors or more, the reactors positioned after the first reactor may be agitated at an identical speed. It is also possible for the reactors positioned after the first reactor to be agitated at an increasing speed, that is to say that the third reactor is agitated at a speed greater than the agitation speed of the second reactor.

The agitation of the reaction medium may be characterized by the Froude number. This parameter is known to those skilled in the art. It is notably defined in the publication: Le génie chimique à l'usage des chimistes [Chemical Engineering for Chemists] by Joseph Lieto, published by Tec & Doc Lavoisier from 1998. The Froude number is calculated according to the following formula: Fr=N²D/g where
g=acceleration of gravity, or 9.81 m/second²
D=diameter of the agitator in metres
N=number of rotations of the agitator in revolutions per second.

When the process according to the invention comprises 2 reactors or more, the Froude number in the first reactor may be less than 0.018 and the Froude number in the following reactor(s) may be greater than 0.018. Preferably, the Froude number in the first reactor is strictly less than 0.018 and the Froude number in the following reactor(s) is greater than or equal to 0.018. More preferentially, the Froude number in the first reactor is strictly less than 0.010 and the Froude number in the following reactor(s) is strictly greater than 0.018.

The ketone may be introduced at the bottom of the reactor and the aqueous hydrogen peroxide solution may be introduced by a tube dipping inside the reactor.

This mixing step leads to the formation of the azine.

At the end of the reaction according to the invention, the reaction mixture comprises the azine, any unreacted ketone, any activator(s), and any other byproducts or impurities.

### Circulation Loop of the Aqueous Solution Saturated With Ammonia

According to one embodiment of the invention, the absorption column of step a) may be fed with a stream of the reaction medium of the reactor of step b). This stream may be withdrawn using a pipe dipping into the reaction medium of the reactor. It is then introduced at the top of the absorption column. Once introduced into the absorption column, this stream originating from the reaction medium of step b) is mixed with the aqueous solution comprising at least one activator, and with fresh ammonia, and optionally with recycled ammonia. At the outlet of the column, the aqueous solution comprising dissolved ammonia in a proportion of between 50% and 100% relative to the saturation of ammonia in pure water at the temperature of the column and comprising at least one activator is sent into the reactor. This circulation loop between the reactor and the absorption column makes it possible to constantly maintain a high content of ammonia in the reaction medium of step b). In other words, the stream withdrawn from the reaction medium of step b) will see its concentration of ammonia increased as it passes through the absorption column, before being reinjected into the reactor.

When the agitation in the reactor is low, i.e. when the agitation is not sufficient to homogenize the reaction medium, the aqueous phase then tends to be present in a greater concentration at the bottom of the reactor. It is thus advantageous to withdraw the aqueous phase-rich reaction medium from this location to introduce it into the absorption column. The withdrawal pipe is thus positioned preferably in the first third of the height of the liquid phase starting from the bottom of the reactor.

According to one embodiment, when the process uses several reactors, the reaction medium of each reactor may be withdrawn and introduced into the absorption column.

According to another embodiment, when the process uses several reactors, the reaction medium of a single reactor may be withdrawn and introduced into the absorption column, for example the first reactor or else the last reactor.

According to yet another embodiment, when the process uses several reactors, the reaction media of several reactors, but not all the reactors, may be withdrawn and introduced into the absorption column.

### c) Separation

After the reaction for preparing the azine, the process according to the invention comprises a step of separating the stream formed on conclusion of step b).

The aqueous phase comprising the activator(s) is separated from the organic phase comprising the azine and any unreacted alkyl ketone by conventional separation means, such as liquid-liquid extraction, distillation, decanting or any combination of these possibilities. Preferably, decanting is used.

The organic phase obtained may comprise the azine, unreacted alkyl ketone, activator(s), and any other impurities.

### Optional Recycling of the Aqueous Phase

Following the separation step c), the aqueous phase may completely or partially undergo a regeneration and concentration step. This aqueous phase thus regenerated and concentrated may be recycled into the absorption column.

During the step of regenerating and concentrating the aqueous phase from the separation step, a stream of gaseous ammonia may be separated and recycled into the absorption column.

### Optional Washing of the Organic Phase

The process may comprise a step of washing the organic phase isolated in step c). The step of washing the organic phase obtained in step c) is a step that may be carried out by techniques known to those skilled in the art, as indicated for example in document WO 2018/065997 (p. 13, “Organic layer processing section”, second paragraph). The washing step notably makes it possible to recover the activator(s), for example acetamide, which is (are) possibly still present in the organic phase.

The washing may be performed in a countercurrent washing column.

The activator(s) possibly still present in the organic phase thus pass(es) into the aqueous washing phase.

According to one embodiment, after passage through the washing column, the resultant aqueous phase may be recycled to step a) with the aqueous phase recovered in step c).

### Optional Distillation of the Organic Phase

The process may comprise a step of distilling the organic phase that has been isolated in step c) and optionally washed. The step of distilling the, optionally washed, organic phase is a step that may be carried out by techniques known to those skilled in the art, as indicated for example in document WO 2018/065997 (p. 13, “Organic layer processing section”), notably in a distillation column.

The distillation step is notably used to separate the azine from the heavy impurities, with high boiling point. These impurities are recovered at the bottom of the column, for example. The distillation step is also used to separate the azine formed in step (b) from the unreacted alkyl ketone, which may be recovered at the top of the column. The alkyl ketone thus recovered may be recycled to the azine synthesis step (b).

Thus, at the end of the washing and distillation steps, a purified organic phase comprising the azine is obtained.

### d) Hydrolysis

The process according to the invention comprises a step of hydrolysing the (purified or non-purified) organic phase obtained in the preceding step to obtain hydrazine hydrate.

The hydrolysis step is performed under pressure, in a reactive distillation column, injected into which is water and the (purified or non-purified) organic phase comprising the azine originating from step c).

The hydrolysis may be performed in a packed or plate distillation column, preferably operating under a pressure of 2 to 25 bar absolute and with a bottom temperature of between 150° C. and 200° C.

While conventional packed columns may be suitable, plate columns are generally employed. Depending on the residence time permitted on the plates and the pressure, and therefore depending on the temperatures of operation, the number of plates may vary greatly. In practice, when operating under a pressure of 8 to 10 bar absolute, the number of plates needed is of the order of 40 to 70.

Obtained following the hydrolysis are:
at the top, the alkyl ketone notably in the form of an azeotrope with water, and
at the bottom, an aqueous hydrazine hydrate solution.

Azine hydrolysis is known. For example, E. C. Gilbert, in an article in Journal of the American Chemical Society vol. 51, pages 3397-3409 (1929), describes equilibrium reactions of azine formation and azine hydrolysis reactions and provides the thermodynamic parameters of the system in the case of water-soluble azines. For example, the hydrolysis of the azine of acetone is described in patent U.S. Pat. No. 4,724,133. For azines insoluble in aqueous solutions, such as for example the azine of methyl ethyl ketone, the hydrolysis must be carried out in a reactive column, such that total hydrolysis is attainable by continually separating methyl ethyl ketone at the top of the distillation column and hydrazine hydrate at the bottom of the column.

When working with the pure azine, i.e. obtained for example from hydrazine hydrate and methyl ethyl ketone, it is actually found when working in accordance with these patents that dilute solutions of hydrazine hydrate are obtained with a good yield.

Taking place in this column are the hydrolysis of the azine and the separation of hydrazine hydrate from the methyl ethyl ketone. These conditions are known. Those skilled in the art will easily determine the number of plates or the packing height, as well as the water and azine feed points. Solutions with 20% or even up to 45% by weight of hydrazine hydrate are obtained at the bottom. For example, the water/azine molar ratio in the feed of this column is at least greater than the stoichiometry and advantageously between 5 and 30, preferably between 10 and 20. The temperature at the bottom of the column may be between 150° C. and 200° C., preferably between 175° C. and 190° C. The pressure depends on the boiling temperature of the azine, the water and the ketone. Such hydrolysis is also described in U.S. Pat. No. 4,725,421 and in WO 00/37357.

The process according to the invention may be carried out continuously or batchwise. Preferably, it is carried out batchwise.

### DESCRIPTION OF THE FIGURE

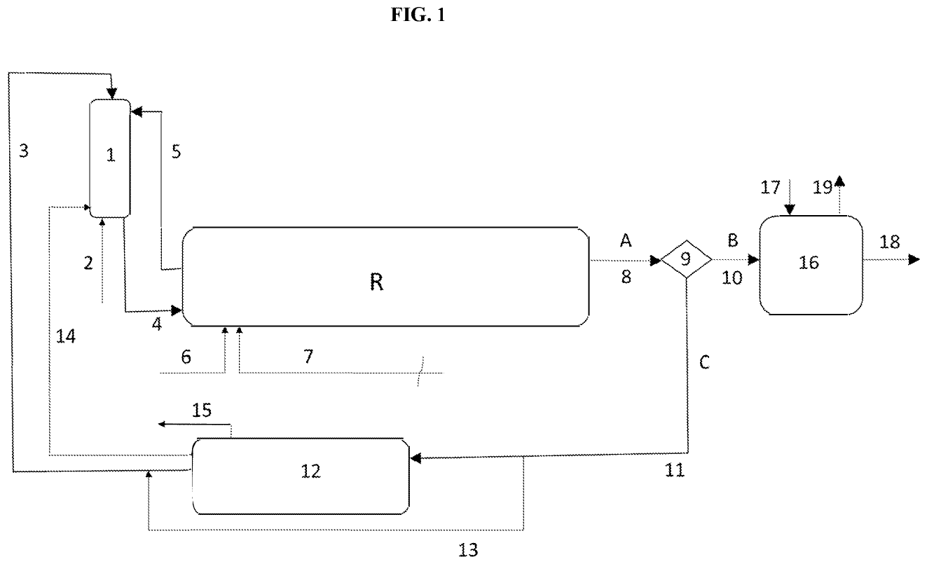

FIG. 1 represents an embodiment of the process according to the invention.

The preparation of the ammoniacal aqueous solution is carried out in the absorption column 1. The column 1 is fed with fresh ammonia via the line 2 and with aqueous solution comprising at least one activator via the line 3.

The ammoniacal aqueous solution comprising at least one activator feeds the reactor R via the line 4.

The line 5, the absorption column 1, the feed line 4 and the reactor R form a loop for recirculating the aqueous solution comprising dissolved ammonia and activator.

The reaction of ammonia, hydrogen peroxide and the alkyl ketone in the presence of a solution comprising at least one activator is carried out in the reactor denoted R.

The reactor R is fed with oxygen peroxide via the line 6. It is fed with ketone via the line 7. This may be a feed with fresh ketone or else a feed recycling a ketone originating from the process.

The line 8 transports the stream A formed in the reactor R to the decanter 9.

The decanter 9 separates the organic phase B and the aqueous phase C. The organic phase B is sent via the line 10 into the hydrolysis column 16. The water is supplied via the line 17. The hydrazine hydrate is recovered via the line 18. The stream of ketone and of water obtained at the top of the column following the hydrolysis of the azine in the hydrolysis column 16 leaves via the line 19.

The aqueous phase C is sent to the unit 12 for regeneration and concentration of the aqueous phase C via the line 11.

The line 13 is a line that bypasses the regeneration and concentration unit 12. Depending on the quality of the aqueous phase, it is possible to direct the aqueous phase C to the unit 12 or else to the bypass line 13. It is also possible to send only part of the aqueous phase C to the regeneration and concentration unit 12. The aqueous phase which has undergone the regeneration and concentration step and/or the aqueous phase which has passed via the bypass line 13 is sent to the top of the absorption column 1 via the line 3. During the regeneration and concentration step, it is also possible to recover ammonia. This ammonia may be recycled via the line 14 to the bottom of the absorption column 1. The regeneration and concentration unit 12 may comprise a purge 15 so as to remove excess water from the circuit.

The examples that follow illustrate the present invention but are not in any way limiting.

### EXAMPLES

### Example 1: Measurement of the Solubility of Ammonia Gas in the Aqueous Phase

Several aqueous phases comprising different contents of water, of ammonium acetate, of acetamide and of MEK (methyl ethyl ketone) were prepared. These aqueous phases were saturated with ammonia at the temperature indicated by flushing with ammonia gas at atmospheric pressure, with stirring, in a reactor equipped with a condenser until the mixture is saturated, i.e. up until the ammonia gas is no longer absorbed and leaves the reactor. The flushing was then continued for another 30 min while reducing the ammonia flow rate. The ammonia content of the aqueous phases was analysed by titration with 1 N sulfuric acid (1 ml of sample).

One experiment was carried out at 50° C. The results are given in Table 2 below:

TABLE 2

| | | | | | Amount of |
|---|---|---|---|---|---|
| T = | composition of the aqueous phase (in g) | | | | NH₃ in g in |
| 50° C. | Ammonium | | | | 100 g of |
| Water | acetate | Acetamide | MEK | NH₃ | H₂O |
| 81.6 | 0.0 | 0.0 | 0.0 | 18.4 | 22.5 |
| 61.5 | 26.3 | 0.0 | 0.0 | 12.2 | 19.9 |
| 37.2 | 55.7 | 0.0 | 0.0 | 7.1 | 19.1 |
| 52.8 | 0.0 | 35.2 | 0.0 | 12.0 | 22.7 |
| 45.4 | 18.1 | 27.2 | 0.0 | 9.3 | 20.5 |
| 21.7 | 31.8 | 25.1 | 16.7 | 4.7 | 21.6 |
| 26.2 | 34.4 | 22.9 | 11.5 | 5.1 | 19.5 |
| 29.3 | 39.9 | 20.0 | 5.0 | 5.9 | 20.2 |
| 31.2 | 48.6 | 13.9 | 0.0 | 6.3 | 20.2 |

A second experiment was carried out at 60° C. The results are given in Table 3 below:

TABLE 3

| | | | | | Amount of |
|---|---|---|---|---|---|
| | composition of the aqueous phase (in g) | | | | NH₃ in g in |
| 60° C. | Ammonium | | | | 100 g of |
| Water | acetate | Acetamide | MEK | NH₃ | H₂O |
| 86.8 | 0.0 | 0.0 | 0.0 | 13.2 | 15.2 |
| 63.8 | 27.4 | 0.0 | 0.0 | 8.8 | 13.8 |
| 37.9 | 56.8 | 0.0 | 0.0 | 5.3 | 14.0 |
| 54.7 | 0.0 | 36.4 | 0.0 | 8.9 | 16.3 |
| 46.5 | 18.6 | 27.9 | 0.0 | 7.0 | 15.1 |
| 29.7 | 40.5 | 20.2 | 5.1 | 4.6 | 15.5 |
| 31.8 | 49.4 | 14.1 | 0.0 | 4.7 | 14.8 |

It is seen that the ammonia contents at saturation in the aqueous phases are close to the solubility values of ammonia in pure water, if the amount of ammonia is related to the amount of water contained in these aqueous phases, i.e. 23.5 g/100 g at 50° C. and 16.8 g/100 g at 60° C. as indicated by Lange's Handbook of Chemistry.

### Example 2: Process According to the Invention

### Description of the Reaction Assembly: Steps a) and b)

The 1000 ml reactor is provided with a double jacket enabling heating to keep the reaction temperature at the desired temperature. It is agitated by a rotating element composed of three straight glass blades with a diameter of 4 cm. A condenser kept at 5° C. by circulation of glycol water is mounted on the reactor. The condenser is connected to a bubbler device filled with silicone oil, which makes it possible to monitor the release of gas and to keep the reaction at atmospheric pressure.

The absorption column is a glass column which has an internal diameter of about 2 cm and is filled to a height of about 10 cm with glass beads with a diameter of about 2 mm. The double wall is kept at a temperature from 25° C. to 30° C. by means of circulation of water via a thermostatically controlled bath. Gas phase pressure equalization is carried out between the headspace of the reactor and the top of the absorption column.

The ammonia gas is injected at the bottom of the absorption column by an adjustable mass flow meter. The ammonia flow rate is reduced if it is observed that the release of gas at the bubbler intensifies.

The recirculation of the aqueous phase of the reactor to the absorption column is carried out by a peristaltic pump; the aqueous phase withdrawn from the reactor is injected at the top of the absorption column. The withdrawal from the reactor of the recirculated aqueous phase is carried out approximately in the first third of the height of the liquid phase starting from the bottom of the reactor.

The ammoniacal aqueous phase is introduced through the top of the reactor, above the liquid phase of the reactor. The hydrogen peroxide is also introduced through the top of the reactor, above the liquid phase of the reactor.

### Procedure

The constituents of the aqueous phase, i.e. the MEK, water, acetamide and ammonium acetate, are introduced into the reactor. The agitation is started and the temperature of the medium is brought to the desired reaction temperature. The pump for recirculating the aqueous phase is also started.

The reactants are introduced in the proportions shown in Table 4 below:

TABLE 4

| | Amount (g) | Amount (moles) |
|---|---|---|
| MEK | 144 | 2 |
| Water | 180 | 18 |
| Acetamide | 177 | 3 |
| Ammonium acetate | 77 | 1 |

The hydrogen peroxide is a commercial 70% aqueous solution.

The agitation of the reaction medium is set at 100 rpm.

When the reaction temperature of 50° C. in the reactor is reached, then the introduction of fresh ammonia and the introduction of H₂O₂ are simultaneously started. 48.6 g of a 70% H₂O₂ solution is poured in over the course of an hour, i.e. a flow rate of 1 mol/h of H₂O₂.

The ammonia flow rate is set at t=0 to 31.8 g/h, i.e. 1.87 mol/h; it is then adjusted during the reaction so as to not have any excess ammonia at the outlet of the bubbler device.

The ammonia content at the outlet of the column and in the aqueous phase was analysed by titration with 1 N sulfuric acid (1 ml of sample).

The percentage of dissolution of ammonia in the aqueous solution at the outlet of the column is calculated relative to the value for ammonia in pure water at 30° C. according to the values in the table from Lange's Handbook of Chemistry, Editor John A. Dean, 12^{th} edition, 1979, on page 10.3, i.e. relative to the value of 41.0 g.

The flow rate of the stream in the recirculation loop is 370 g/h.

A sample is taken to determine the content of MEKazine in the reactor.

The yield of MEKazine is calculated according to the following calculation: number of moles of azine formed/theoretical number of moles of azine (i.e. 1 mol per mole of H₂O₂).

The data for the reaction are given in Table 5 below:

TABLE 5

| | | | | | NH₃ g/100 g | |
|---|---|---|---|---|---|---|
| | NH₃ flow | total NH₃ | Yield | NH₃ g/100 g | of water at | % dissolution |
| time | rate | introduced | MEKazine | of water in | the outlet of | of NH₃ at |
| (h) | (mol/h) | (g) | (%) | the reactor | the column | 30° C. |
| 0 | 1.87 | 0 | 35 | — | — | — |
| 2 | 0.47 | 63.5 | 67 | — | 35 | 85 |
| 4 | 0.12 | 79.5 | 79 | — | — | — |
| 5.8 | 0.06 | 83 | 86 | — | 27 | 66 |
| 8 | stop | 85.2 | — | 22.5 | 26 | 63 |

Description of the Reaction Assembly: Step c

The MEKazine is recovered after a decanting step.

### Description of the Reaction Assembly: Step d

The apparatus consists of a distillation column with a height of 2.5 m and a diameter of 20 mm which is packed with Raschig rings (diameter of 5 mm) and provided with temperature sensors at several locations along the column. The top of the column is provided with a condenser and a device making it possible to set the flow rate of condensate returned to the top of the column and of condensate withdrawn. The reflux ratio is set by a timer device (mass ratio of the reflux flow rate to flow rate withdrawn).

The boiler at the bottom of the column has a volume of 160 ml, and is provided with a device making it possible to visualize the liquid level. A manual withdrawal at the boiler makes it possible to withdraw the hydrazine hydrate solution produced and keep the liquid level substantially constant in the boiler.

Water and MEKazine are introduced by pumps in the first third of the column starting from the top.

All of the assembly is designed to work under the desired working pressure (8 bar absolute) and is provided with a 12 bar burst seal as a safety measure.

### Conditioning of the Column

A hydrazine hydrate solution comprising 25% of hydrazine hydrate (N₂H₄·H₂O) is introduced into the boiler and the bottom temperature is gradually increased until water vapours arrive at the top of the column. The pressure is set at 8 bar absolute.

### Hydrolysis of the Azine

The introductions of water at a flow rate of 36 g/h (2 mol/h) and of the methyl ethyl ketone azine at a flow rate of 28 g/h (0.2 mol/h) are then started simultaneously. When the column reaches equilibrium, the reflux ratio at the top of the column is then set at 0.5 and the hydrazine hydrate is continuously withdrawn at the bottom in order to keep a constant level in the boiler.

The operation is performed for about 8 h of operation. The bottom temperature is 178-177° C., and the top temperature is 150-151° C.

During the operation, 31 g/h of an aqueous solution with a concentration of 31% of hydrazine hydrate (expressed as N₂H₄·H₂O) is thus withdrawn at the bottom of the column. 32 g/h of methyl ethyl ketone containing 12% of water is withdrawn at the top.

### Example 3: Process According to the Invention

The process of Example 3 follows the same process as that of Example 2, with the exception that the flow rate of the stream in the recirculation loop is modified: it is doubled.

The data for the reaction are given in Table 6 below:

TABLE 6

| | | | | | NH₃ g/100 g | |
|---|---|---|---|---|---|---|
| | NH₃ flow | total NH₃ | Yield | NH₃ g/100 g | of water at | % dissolution |
| time | rate | introduced | MEKazine | of water in | the outlet of | of NH₃ at |
| (h) | (mol/h) | (g) | (%) | the reactor | the column | 30° C. |
| 0 | 1.87 | 0.0 | 35 | — | — | — |
| 2 | 0.47 | 63.6 | 67 | — | 26 | 63 |
| 4 | 0.16 | 79.5 | 79 | — | — | — |
| 5.8 | 0.08 | 84.2 | 86 | — | 24 | 59 |
| 8 | stop | 87.2 | — | 21.5 | 22 | 54 |

These results show that a very good yield is obtained, with an optimal ammonia consumption.

1. Process for preparing hydrazine hydrate, comprising the following successive steps:
a) preparation by means of an absorption column of an aqueous solution comprising dissolved ammonia in a proportion of between 50% and 100% relative to the saturation of ammonia in pure water at the temperature of the column and comprising at least one activator, by introduction into the absorption column of an aqueous solution comprising at least one activator and of fresh ammonia; then
b) reaction within at least one reactor of the aqueous ammonia solution comprising at least one activator obtained in the preceding step with hydrogen peroxide and a ketone of formula R₁R₂CO, the groups R₁ and R₂ denoting, independently of one another, a methyl, ethyl, propyl, butyl, pentyl, hexyl, heptyl and octyl group; then
c) separation of the organic phase containing the azine from the aqueous phase from the stream formed on conclusion of the preceding step; then
d) hydrolysis of the organic phase obtained in the preceding step to obtain hydrazine hydrate.

2. Process according to claim 1, characterized in that, in step a), the aqueous solution comprising at least one activator is introduced at the top of the absorption column and the fresh ammonia is introduced in countercurrent, preferably at the bottom of the absorption column.

3. Process according to claim 1, characterized in that a stream of the reaction medium of the reactor of step b) feeds the absorption column of step a), this stream being injected at the top of the column.

4. Process according to claim 1, characterized in that the aqueous solution isolated in step c) is recycled into the absorption column of step a).

5. Process according to claim 1, characterized in that the absorption column of step a) is fed with one or more streams of ammonia that has been recycled within the process.

6. Process according to claim 1, characterized in that the ketone used in step b) is methyl ethyl ketone.

7. Process according to claim 1, characterized in that it comprises a step of regenerating and concentrating the aqueous phase from the separation step c).

8. Process according to claim 1, characterized in that it comprises a step of washing the organic phase, from the separation step c).

9. Process according to claim 1, characterized in that the process is carried out batchwise.

10. Process according to claim 1, characterized in that the process is carried out continuously.
